(19) United States
(12) Patent Application Publication
(10) Pub. No.: US 2008/0191943 A1
(43) Pub. Date: Aug. 14, 2008

(54) Antenna device having membrane structure

(76) Inventor: Hsin Heng Wu, Chonli City (TW)

Correspondence Address: CHARLES E. BAXLEY, ESQUIRE, 90 JOHN STREET, SUITE 309, NEW YORK, NY, 10038, US

(21) Appl. No.: 11/264,843

(22) Filed: Nov. 1, 2005

(51) Int. Cl. H01Q 9/04

(52) U.S. Cl. 343/700 MS

(57) ABSTRACT

An antenna device includes a membrane, and a conductor wire coupled to the membrane for electrically coupling the membrane to various electric facilities or telecommunication apparatus, the membrane is preferably made of metallic reflective material that may be applied onto the typical compact discs and that includes a conductivity and dielectric coefficient for facilitating a signal receiving and transmitting effect to the antenna device. The membrane may include a flexible structure and attachable onto various objects to conform the outer contours of the objects.

### BACKGROUND OF THE INVENTION

1. Field of the Invention

The present invention relates to an antenna device, and more particularly to an antenna device having a membrane structure and having a greatly reduced thickness for allowing the antenna device to include a greatly decreased weight and to be easily attached onto various non-conductive materials.

2. Description of the Prior Art

Typical electric facilities or telecommunication apparatuses, such as computers, personal digital assistants, portable or mobile phones, phone systems, radio and/or video facilities, global systems for mobile communications, vehicles, wireless network systems, etc. comprise one or more antenna devices attached thereto for signal receiving and/or transmitting purposes.

For allowing the antenna devices to be easily attached onto various objects, or to be easily carried with the users, the sizes or volumes or areas of the antenna devices have been reduced. However, the antenna devices are normally made of metallic materials and should have or include a predetermined thickness and thus should include a predetermined weight such that the antenna devices also may not be easily attached onto various objects.

For example, U.S. Pat. No. 6,255,994 to Saito discloses one of the typical antenna devices including a radiating element having a form of a conductor plate, or formed into the conductor plate which may include a relatively decreased thickness and weight. However, similarly, the antenna devices should also include a predetermined thickness and weight that may not be easily attached onto various objects without latches or fasteners or the like, and may not be attached onto various objects with adhesive materials or the like.

The present invention has arisen to mitigate and/or obviate the afore-described disadvantages of the conventional antenna devices for electric facilities or telecommunication apparatuses.

### SUMMARY OF THE INVENTION

The primary objective of the present invention is to provide an antenna device including a membrane structure having a greatly reduced thickness for allowing the antenna device to include a greatly decreased weight and to be easily attached onto various objects or non-conductive materials without latches or fasteners or adhesive materials.

In accordance with one aspect of the invention, there is provided an antenna device comprising a membrane, and a conductor wire coupled to the membrane for electrically coupling the membrane to various electric facilities or telecommunication apparatus, the membrane is made of metallic reflective material having a conductivity and dielectric coefficient for facilitating a signal receiving and transmitting effect to the antenna device.

The membrane may include a flexible structure and attachable onto various objects to conform the outer contours or configurations of the objects.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of an antenna device in accordance with the present invention; and

FIG. 2 is a perspective view illustrating the operation or the application of the antenna device.

### DETAILED DESCRIPTION OF THE PREFERRED EMBODIMENT

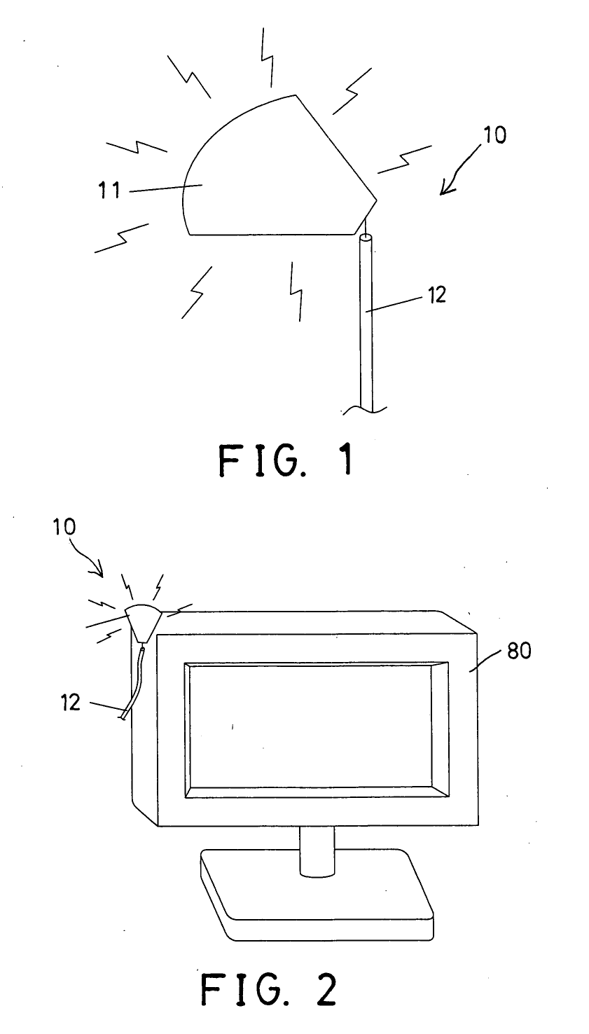

Referring to the drawings, and initially to FIG. 1, an antenna device 10 in accordance with the present invention comprises a membrane 11, and an electric wire or cable or conductor line or wire 12 coupled to the membrane 11 for electrically coupling the membrane 11 to various electric facilities or telecommunication apparatuses, such as computers, portable computers, personal digital assistants, portable or mobile phones, phone systems, radio and/or video facilities, global systems for mobile communications, vehicles, wireless network systems, etc.

The membrane 11 is preferably made of a metallic reflective material or layer that is provided for applied or attached onto various discs, such as VCD, DVD, CD, etc., and that includes a relative greater conductivity or dielectric coefficient, for allowing the membrane 11 to have a greater or excellent signal receiving and/or transmitting effect, or for facilitating the signal receiving and/or transmitting effect to the antenna device 10. In addition, the membrane 11 include a greatly reduced size or volume or area or thickness or weight, to allow the antenna device 10 to be easily and readily attached onto various objects, or to be easily carried with the users.

In operation, as shown in FIG. 2, the membrane 11 of the antenna device 10 may be easily attached onto various objects 80, such as the non-conductive objects 80, the monitor 80 (FIG. 2), the hand phone (not shown), the vehicle (not shown), the computer or the portable computer or the personal digital assistant or the like (not shown). For example, the membrane 11 of the antenna device 10 may be easily attached onto the objects 80 with such as the static electricity, without latches or fasteners or adhesive materials. In addition, the membrane 11 is flexible and may thus be attached and shaped to conform the outer contour or configuration of the objects 80.

The typical antenna devices failed to disclose or to teach or to provide a membrane having a greatly reduced thickness or weight and to allow the membrane type antenna device to be easily attached onto various objects.

Accordingly, the antenna device in accordance with the present invention includes a membrane structure having a greatly reduced thickness for allowing the antenna device to include a greatly decreased weight and to be easily attached onto various objects or non-conductive materials without latches or fasteners or adhesive materials.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna device comprising:
a membrane, and
a conductor wire coupled to said membrane for electrically coupling said membrane to various electric facilities or telecommunication apparatus,
said membrane being made of metallic reflective material having a conductivity and dielectric coefficient for facilitating a signal receiving and transmitting effect to said antenna device.

2. The antenna device as claimed in claim 1, wherein said membrane is flexible and attachable onto an object to conform an outer contour of the object.
